(19) United States
(12) Patent Application Publication
(10) Pub. No.: US 2010/0297590 A1
(43) Pub. Date: Nov. 25, 2010

(54) Measurement Teaching Aid and Manipulative

(76) Inventor: Lora A. Owens, Kenosha, WI (US)

Correspondence Address: JANSSON SHUPE & MUNGER LTD., 245 MAIN STREET, RACINE, WI, 53403, US

(21) Appl. No.: 12/784,322

(22) Filed: May 20, 2010

Related U.S. Application Data
(60) Provisional application No. 61/180,698, filed on May 22, 2009.

(51) Int. Cl. G09B 19/02

(52) U.S. Cl. 434/187

(57) ABSTRACT

A teaching aid is disclosed herein that includes at least one gallon container, two half-gallon containers, four quart containers, two pint containers, and two half-pint containers. Each equivalent measurement may be attached to one another thus showing and teaching students equivalencies of each measurement in volume and capacity. A method for teaching students is also disclosed herein, using the teaching aid in conjunction with associated lesson plans and study guides.

### RELATED APPLICATION

This application is based on U.S. Provisional Application 61/180,698 filed on May 22, 2009.

### FIELD OF THE INVENTION

The present invention is generally related to teaching aids and particularly to math and measurement teaching aids and manipulatives. More particularly, the invention is related to liquid measurement teaching aids and manipulatives.

### BACKGROUND

It is desirable for young children and individuals, and particularly those with special needs, to learn information about spatial relationships and measurements and, in particular, about liquid measurements. Such knowledge is useful in everyday life including performing the tasks of cooking, grocery shopping and preparing food recipes.

Teaching dimensional relationships to groups of students, such as in a classroom environment, often has created difficulties, both from the instructor's ability to easily demonstrate the information he or she is attempting to convey both visually and conceptually, and the ability of the student to see, understand and retain such information. Previously, education about liquid measurements has been conducted by means of lecture or explanation assisted by reference to printed literature, slides, videos, charts and posters, sometimes assisted by use of white or blackboards, models and the like.

The prior art teaching aids suffer from a number of shortcomings. Methods using lecture, explanation and board illustration, as well as those referring to diagrams, literature and the like are not effective to convey the relationship between various sizes and shapes of standard liquid measurements. In addition, known teaching aids may not readily gain attention, especially of children and mentally challenged individuals including special needs individuals, for a sufficiently long span of time. Such models are of little assistance in relating the concepts of liquid measurements to real-life examples of how such measurement would be used.

Thus, an unresolved need exists in the industry to address the aforementioned deficiencies and other inadequacies.

### SUMMARY

The present invention provides an apparatus and method for facilitating the teaching of students, including special needs students, and mentally challenged individuals about math and measurements, and particularly liquid measurements. Briefly described, one preferred embodiment of the teaching aid, among others, includes a liquid gallon container, the gallon container including a top, bottom and four sides; two half-gallon containers, each half-gallon container including a top, bottom and four sides, at least two liquid quart containers positioned below at least one half-gallon container, each quart container including a top, bottom and four sides; at least two liquid pint containers positioned below at least one quart container, each of the pint containers including a top, bottom and four sides; and at least two liquid half-pint containers positioned below at least one pint model. Another preferred embodiment of the teaching aid includes hanging the apparatus including a gallon container, two half-gallon containers, four quart containers, eight pint containers and sixteen half-pint containers as a mobile for display and manipulation in the education process and the like.

The present invention can also be viewed as providing methods for teaching students, particularly about liquid measurements and capacities, and relating these concepts to real-life examples. In this regard, one embodiment of such a method, among others, includes the steps of using a teaching aid, wherein the teaching aid includes the containers and mobiles described above. Another preferred embodiment of such a method, among others, includes the steps of using a studying guide, wherein the studying guide includes using the containers and mobile described above.

The present invention has numerous advantages, a few of which are delineated hereafter as preferred embodiments. The teaching aid is large enough to be seen by a group of students, and the models are configured in such a way that the students can relate the liquid measurements to objects that they see every day, e.g., a gallon container of milk, quart-sized carton of juice and a half-pint of milk or juice provided to the students in the school cafeteria or from vending machines. Most students are disconnected visually from the current containers such as beakers, cylinders and the like. However the majority of students can connect to the containers that milk and juice are sold in, as the students see this everyday in school and in public vending machines, and such are available in school cafeterias. Accordingly students can better associate measurements, capacities and quantities (i.e. how much) and their equivalencies. Additionally, by directly relating the known and understood everyday physical containers to each other, students are able to more easily grasp the idea of how measurements, capacities and quantities relate to one another.

Other advantages of the invention are that it is simple in design, user friendly, robust and reliable during use, and easily implemented for mass commercial production. Clearly, some embodiments of the invention may exhibit advantages in addition to, or lieu of, those mentioned above. Additionally, other methods, features, and advantages of the present invention will be or become apparent to one with skill in the art upon examination of the following drawings and detailed description. It is intended that all such additional methods, features, and advantages be within the scope of the present invention and be included within this description.

### BRIEF DESCRIPTION OF THE DRAWINGS

Many aspects of the invention can be better understood with reference to the following drawings. In the drawings, like reference numerals designate corresponding parts throughout the several views.

In order that the advantages of the invention will be readily understood, a more detailed description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a picture of an embodiment of the teaching aid of the present invention;

FIG. 2 is a detailed view of an embodiment of the gallon container of FIG. 1;

FIG. 3 is a detailed view of an embodiment of the half-gallon containers of FIG. 1;

FIG. 4 is a detailed view of an embodiment of the pint and half-pint containers of FIG. 1;

FIG. 5 is a close up of an embodiment of the fasteners used to connect the quart and pint containers as shown in FIG. 1;

FIG. 6 is a detailed view of the connection between the quart and pint containers and fasteners used therefore as shown in FIG. 1;

FIG. 7 is a detailed view of a preferred embodiment of a retaining structure for holding one tier of the containers;

FIG. 8 is a close-up view of the retaining structure of FIG. 7;

FIG. 9 is a detailed view of another embodiment of the retaining structure showing the hanging mobile of the teaching aid and manipulative of the present invention with the containers in place;

FIG. 10 is a view of the retaining structure of FIG. 9 with the containers removed;

FIG. 11 is a close-up view of the gallon tier of the retaining structure of FIG. 9 with the container removed;

FIG. 12 is a close-up view of the half-gallon tier of the retaining structure of FIG. 9 with the containers removed;

FIG. 13 is a detailed view of the retaining structure of FIG. 7 with the containers in place;

FIG. 14 is a detailed view of the retaining structure of FIG. 7 with the containers removed;

FIG. 15 is a detailed view of another preferred embodiment of a retaining structure for holding one tier of the containers;

FIG. 16 is a close-up view of the retaining structure for holding one tier of the containers of FIG. 15; and

FIG. 17 is a detailed top view of the retaining structure for holding one tier of the containers of FIG. 15.

### DETAILED DESCRIPTION

The present invention includes a teaching aid and a method for facilitating the teaching of students about measurements. In particular, the teaching aid relates liquid measurements, capacities, quantities and volumes by using containers seen and used every day. In addition, the teaching aid provides an immediate visual and manipulative understanding of common and standard liquid measurements, volume measurements, capacities and quantities, and their equivalences. Reference will now be made to the drawings.

The preferred embodiment includes a measuring mobile 10 which provides both visual and manipulative learning functions. When connected the containers show equivalent measurement from one (1) gallon 5 to two (2) half-gallons 6, from two (2) half-gallons 6 to four (4) quarts 7, from four (4) quarts 7 to eight (8) pints 8, and finally from eight (8) pints 8 to sixteen (16) half-pints 9. Half-pints 9 are the containers that are used in schools to serve milk and are very familiar to the school aged children and special needs individuals who are learning and re-learning liquid measurements and related concepts. When disconnected, the containers individually can be used to help students and special needs individuals generalize measurements. In addition, the containers can be filled with liquid to illustrate and assist in learning about capacity, volumes and quantities.

As illustrated, the containers include one plastic gallon container 5, two plastic half gallon containers 6, four plastic quart containers 7, eight plastic pint containers 8, sixteen card board or plastic half milk pint containers 9. The half-pint containers are those readily recognized by student and special needs individuals as that are available in school vending machines and served in school and other cafeterias. Each group of plastic containers show the equivalence to one gallon. This will help students generalize and convert numbers to corresponding equivalencies. Attachments fasten containers together to form the mobile as a visual and a manipulative.

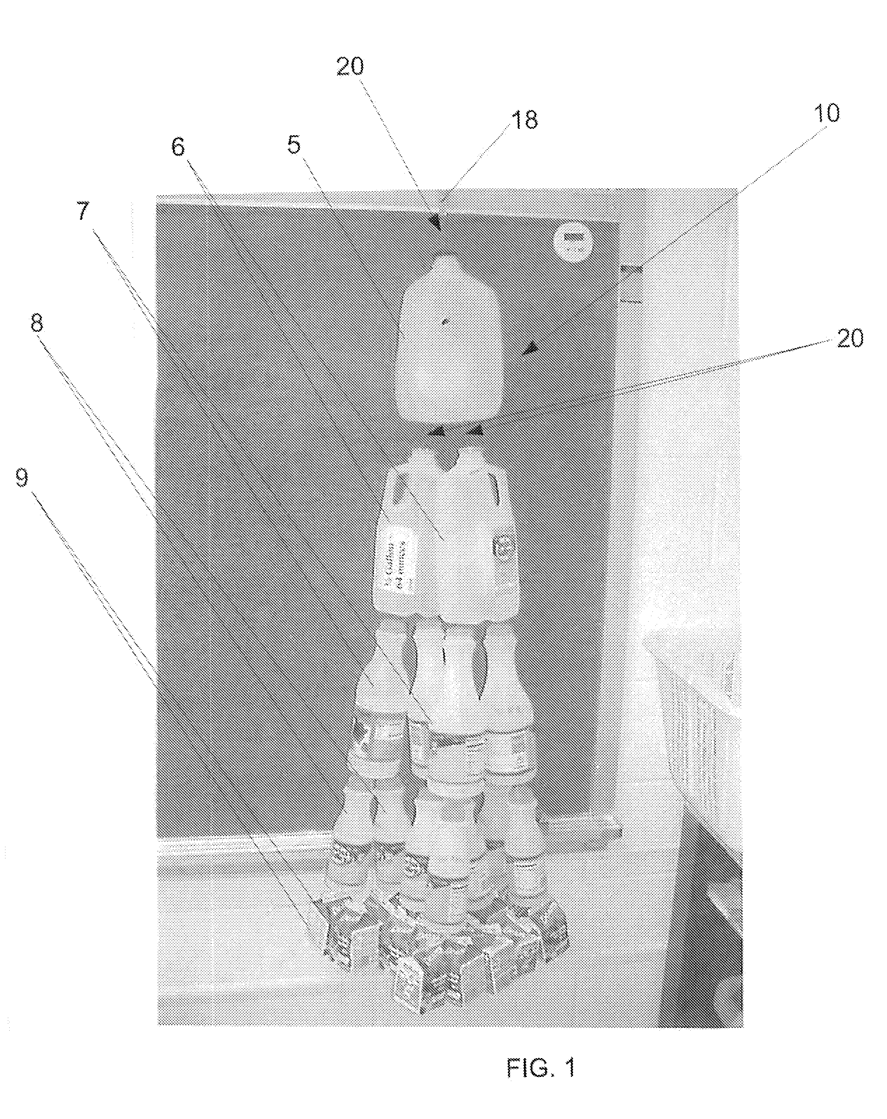

As illustrated in FIGS. 1-3, line 20 is connected between gallon container 5 and half-gallon containers 6. Such attachment using line 20 also fastens half-gallon containers 6 to quart containers 7, quart containers 7 to pint containers 8 and pint containers 8 to half-pint containers 9. It is contemplated that the three-dimensional mobile 10 can be disassembled, the containers separated and subsequently filled to show standard measurements and capacities. The containers 5, 6, 7, 8, and 9 of mobile 10 can be filled with liquids such as clear water, colored water or other substances for educational purposes including visualization of measurements and capacities for cooking, constructing recipes, grocery shopping and the like including equivalent measurements. Specifically, mobile 10 provides immediate visual recognition of standard measurements and their equivalencies.

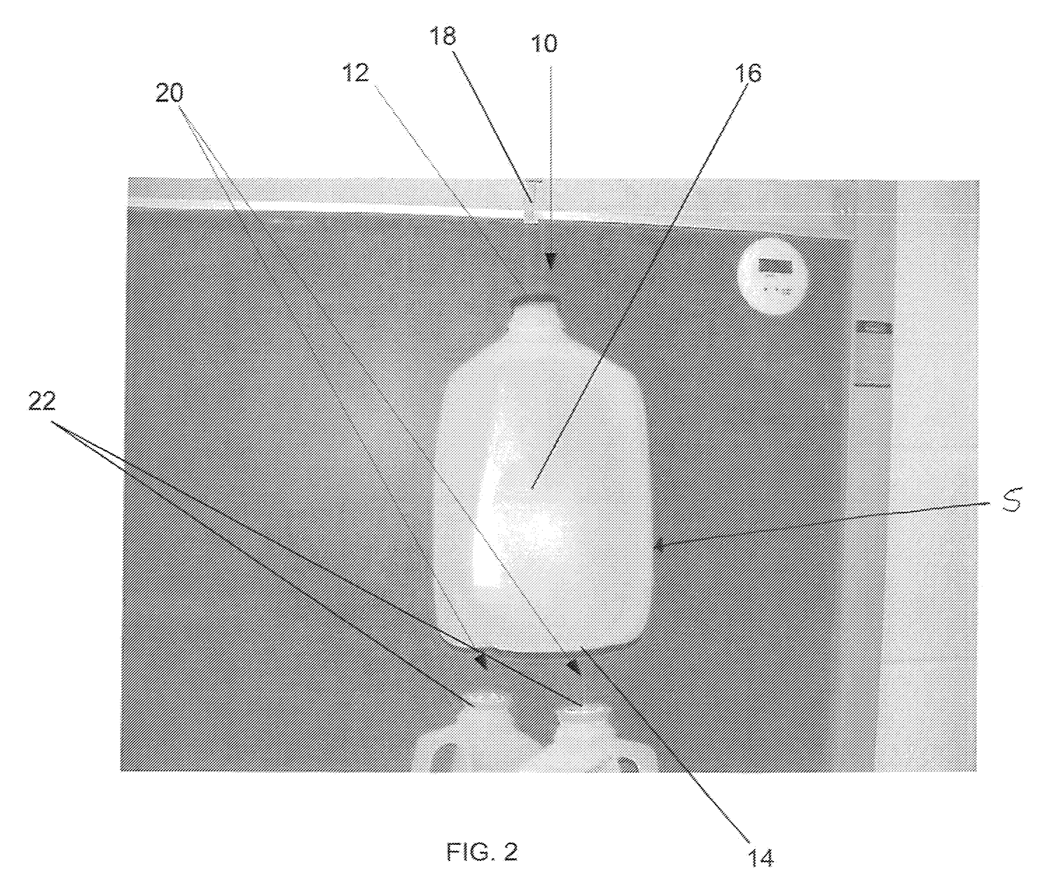

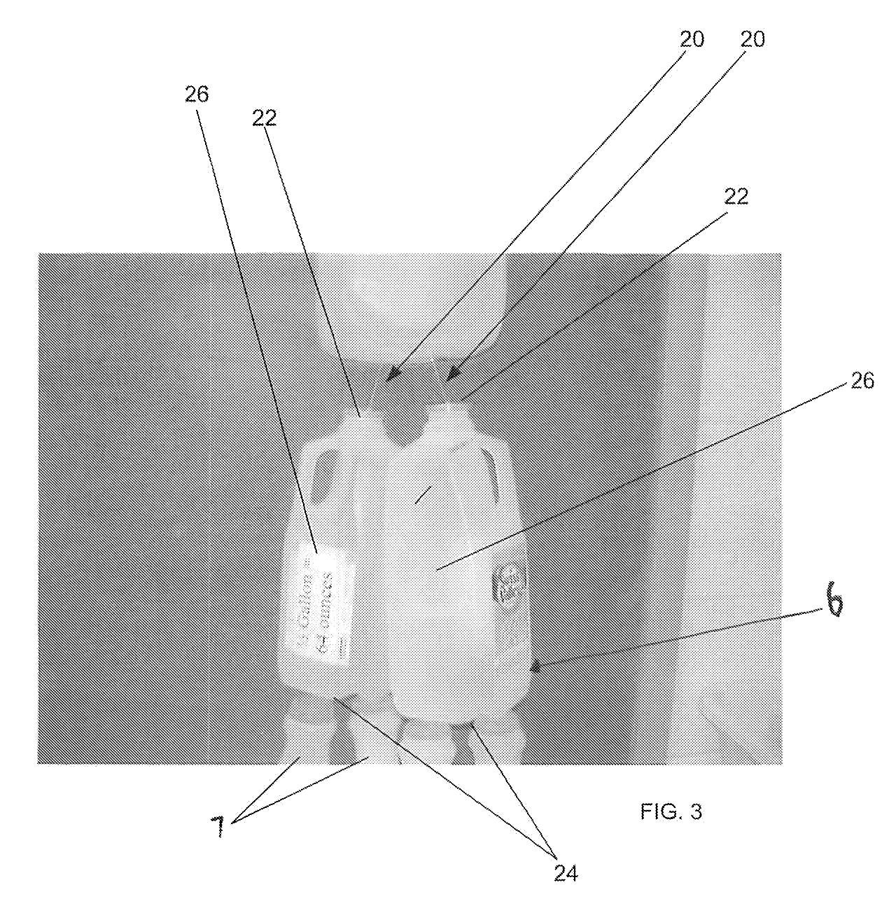

As shown in FIGS. 2 and 3, a gallon container 5 includes a top 12, bottom 14 and side wall 16. To use the teaching aid, a preferred embodiment is illustrated which allows the mobile 10 to be hung from a structure such as hook 18. Gallon container 5 is connected to two half-gallon containers at their tops 22 by monofilament line 20.

Each half-gallon container 6 includes a top 22, bottom 24 and side walls 26. Similarly, each half-gallon container 6 is attached to a quart container 7. The last tier provides connection in a similar manner to the gallon, half-gallon and quart connection described, and connect pint containers 8 with half-pint containers 9.

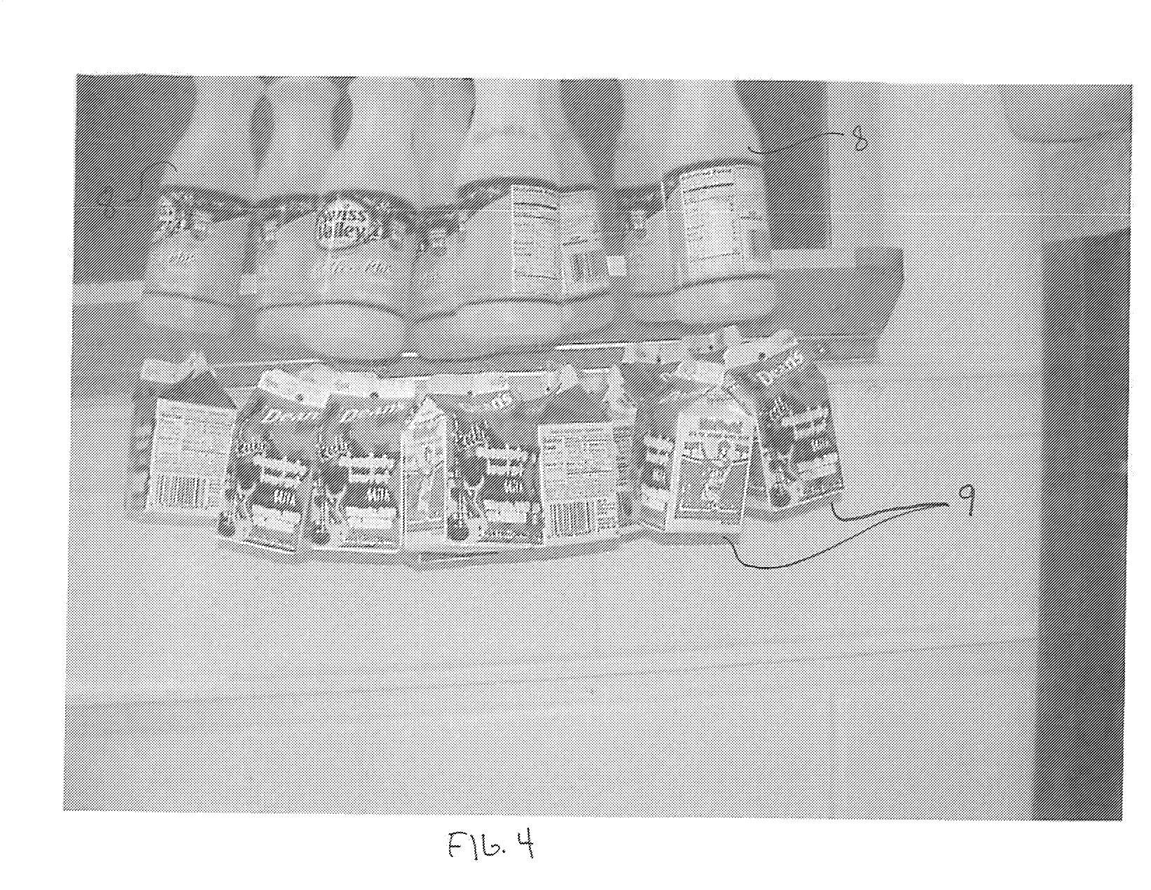

Several preferred methods of connecting the plastic containers are possible such that the equivalent containers are interchangeable to show the equivalency of the standard measurements. One preferred method is illustrated in FIGS. 1-6 providing thirty two (31) clear or see-through containers or a combination of clear and see-through containers with opaque containers such as cartons 9. It is preferred that all of the containers include measurement lines or fill lines to illustrate how much each container holds.

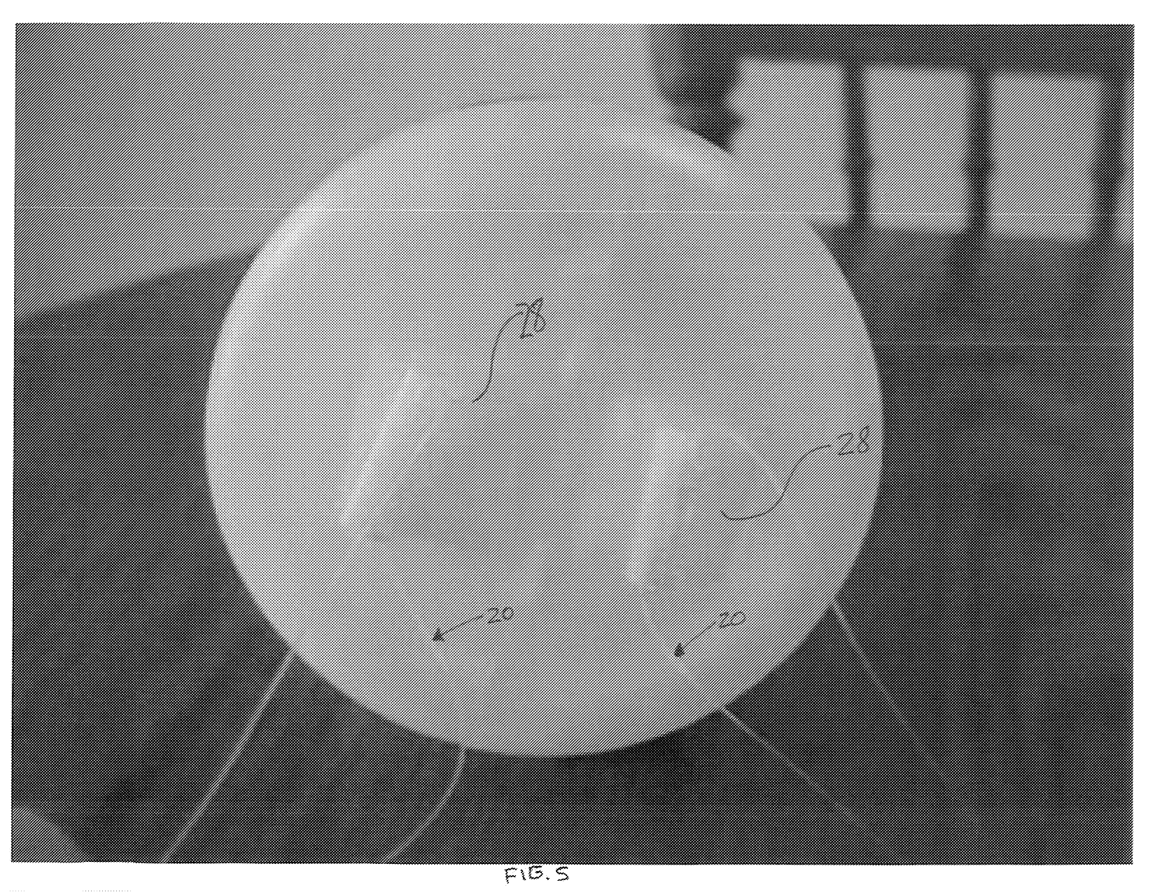

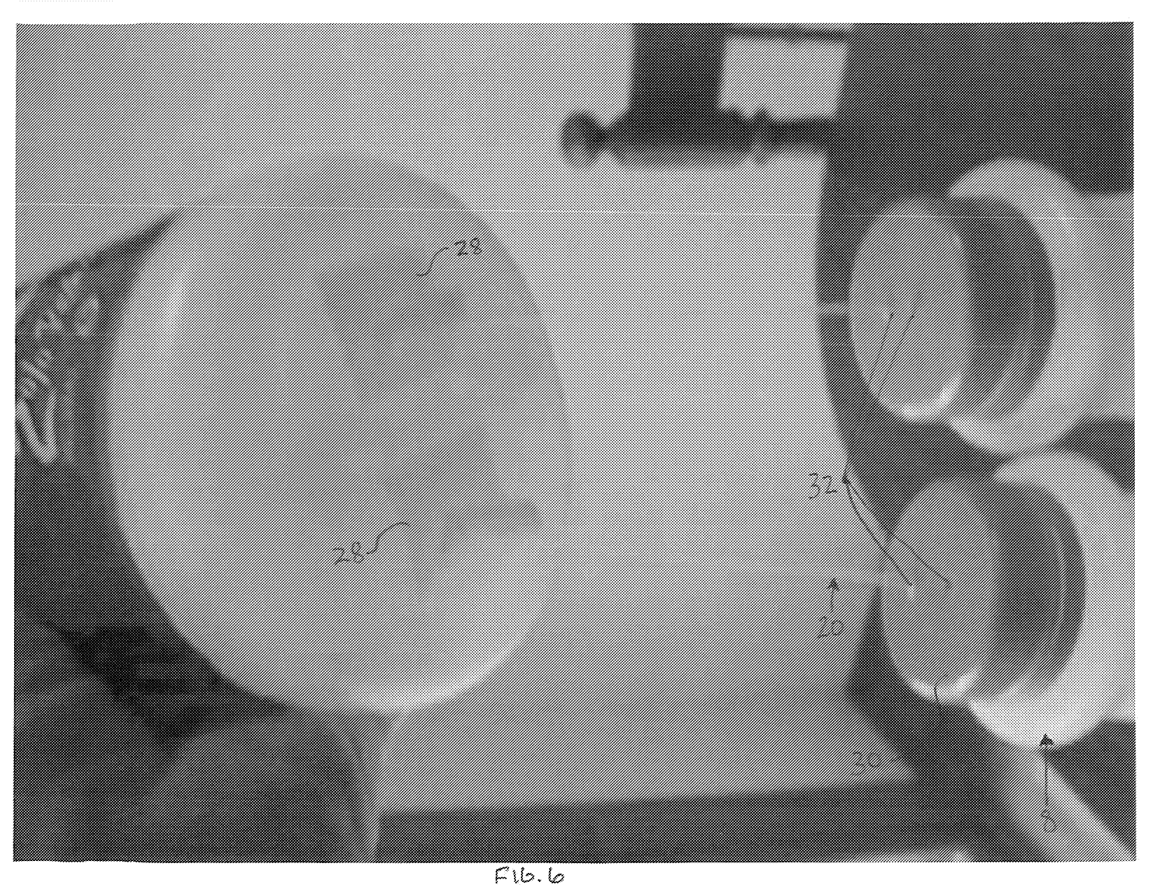

As illustrated in FIGS. 5 and 6, each container is connected to the container or containers below it by Velcro® or a similar removable hook and eye fastener 28, adhesive or other type of fastener. The bottom of each container with the exception of the half-pint containers includes hook and eye connector 28 such as Velcro® or the like. The top or lid of each container has string, wire, monofilament line or a similar thread like connector positioned through two apertures 32 in the top or lid of each container. Such connection is illustrated in FIG. 6 showing the lid 30 of pint container 8 each with two holes 32 therein. The thread is positioned through each apertures 32 and then connected to the hook and eye connector positioned on the bottom of the quart container 7, immediately above pint container 8. Connection in this manner fastens thread 20 as described and quart container 7 and pint container 8 together as shown in FIGS. 1 and 6.

Accordingly, the gallon is positioned for hanging on a hook or other attachment 18 allowing the two half-gallon containers 6 to be hung below the gallon container 5, two of the quart containers 7 to be hung under each of the half-gallon containers 6, two of the pint containers 8 to be hung under each quart container 7 and two of the half-pint containers 9 to be hung under each of the pint containers 8 as illustrated in FIG. 1. Each level starting out with gallon container 5 shows equivalency with the level below it. The same equivalency is illustrated with each level above starting at the bottom and working upward, with the exception of the gallon container 5, which forms the top of the mobile. It is contemplated that each level may be interchangeable with the exception of the first level, gallon 5, which must remain as the first level so the complete structure can be hung as a mobile.

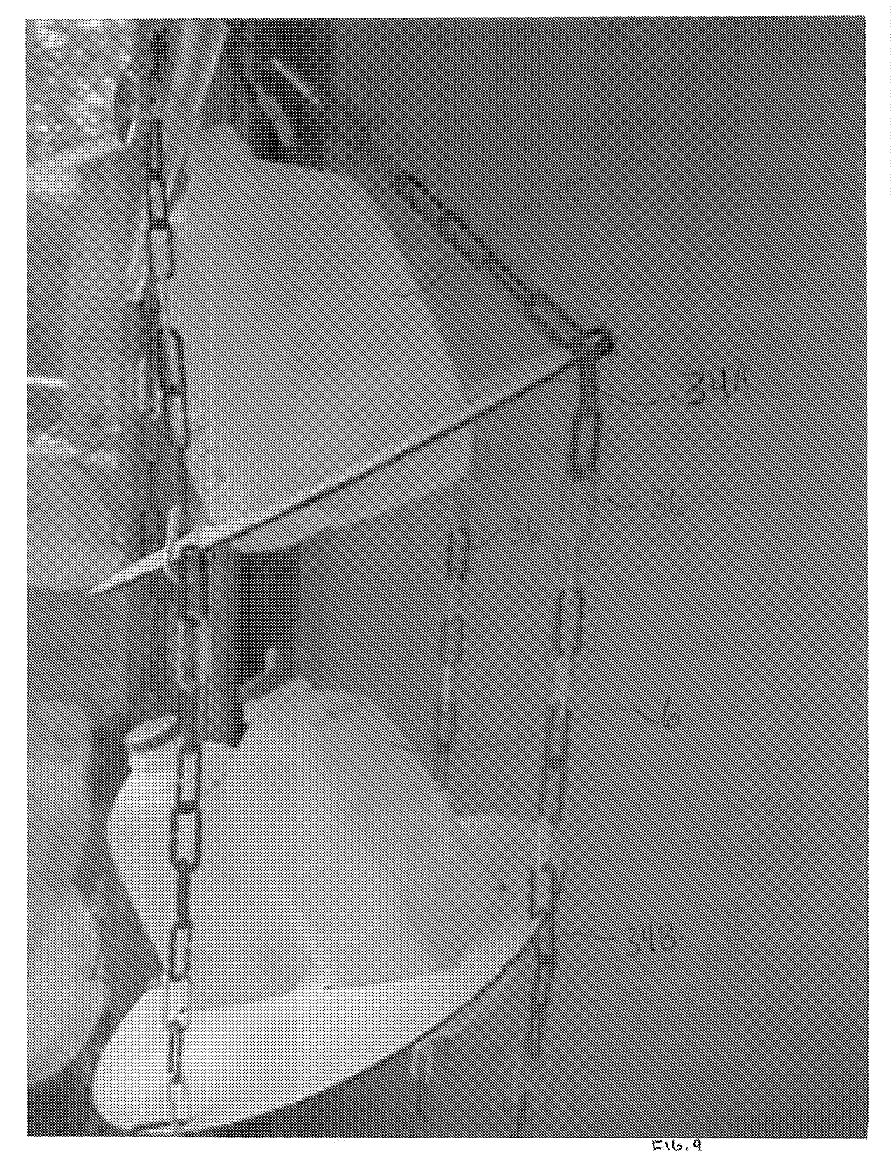

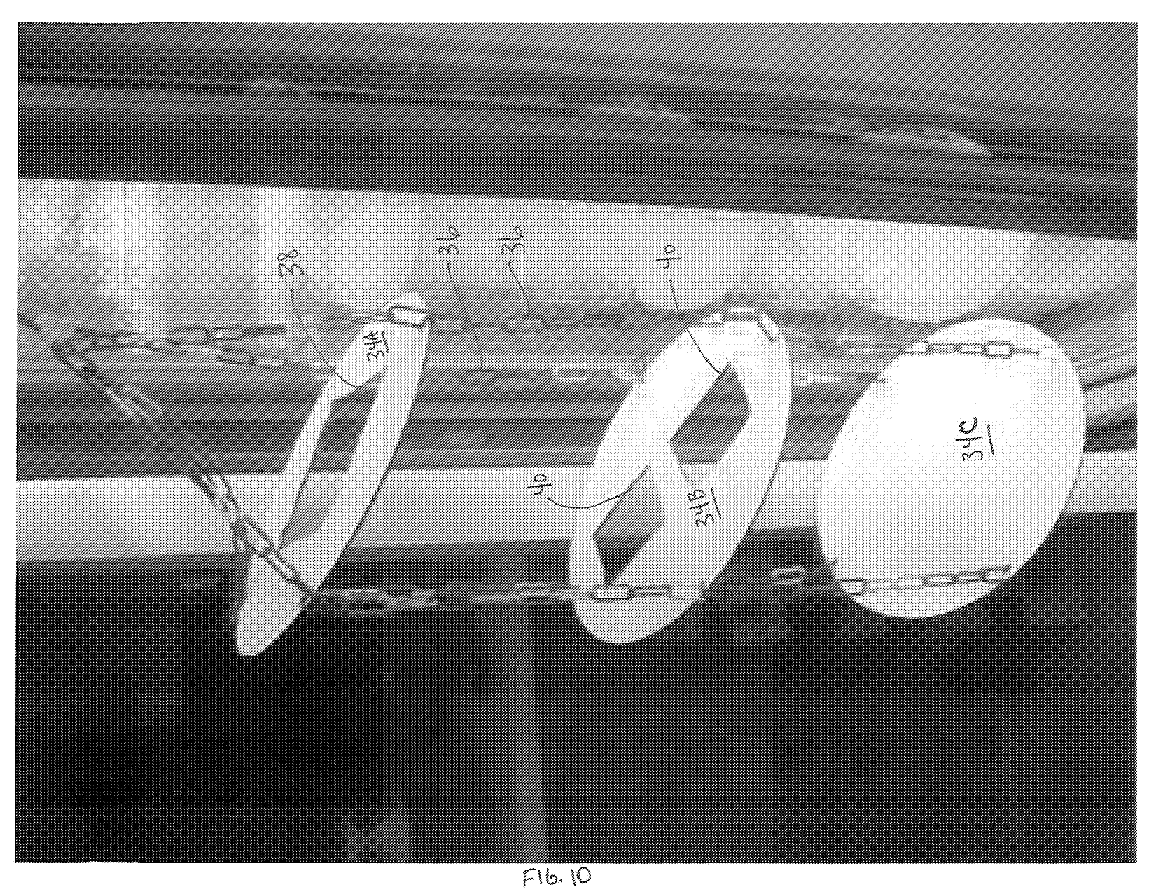

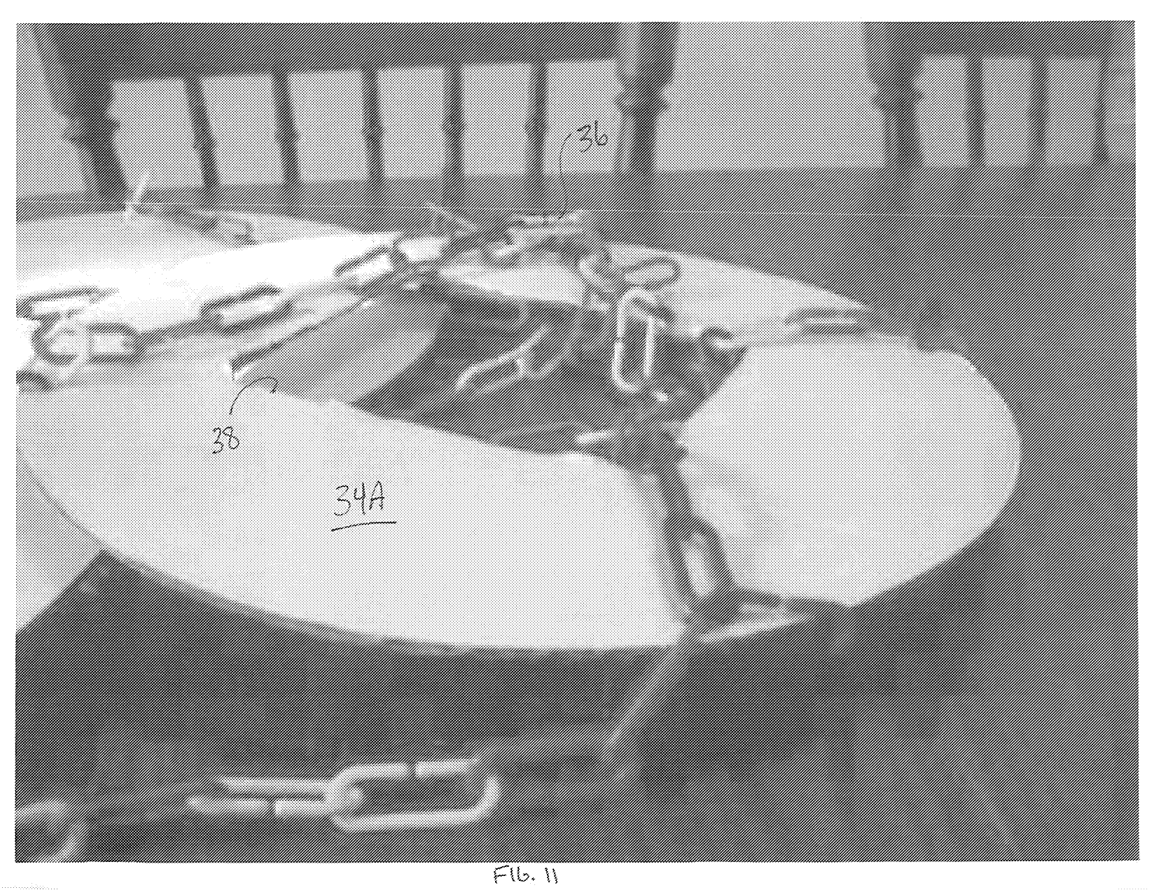

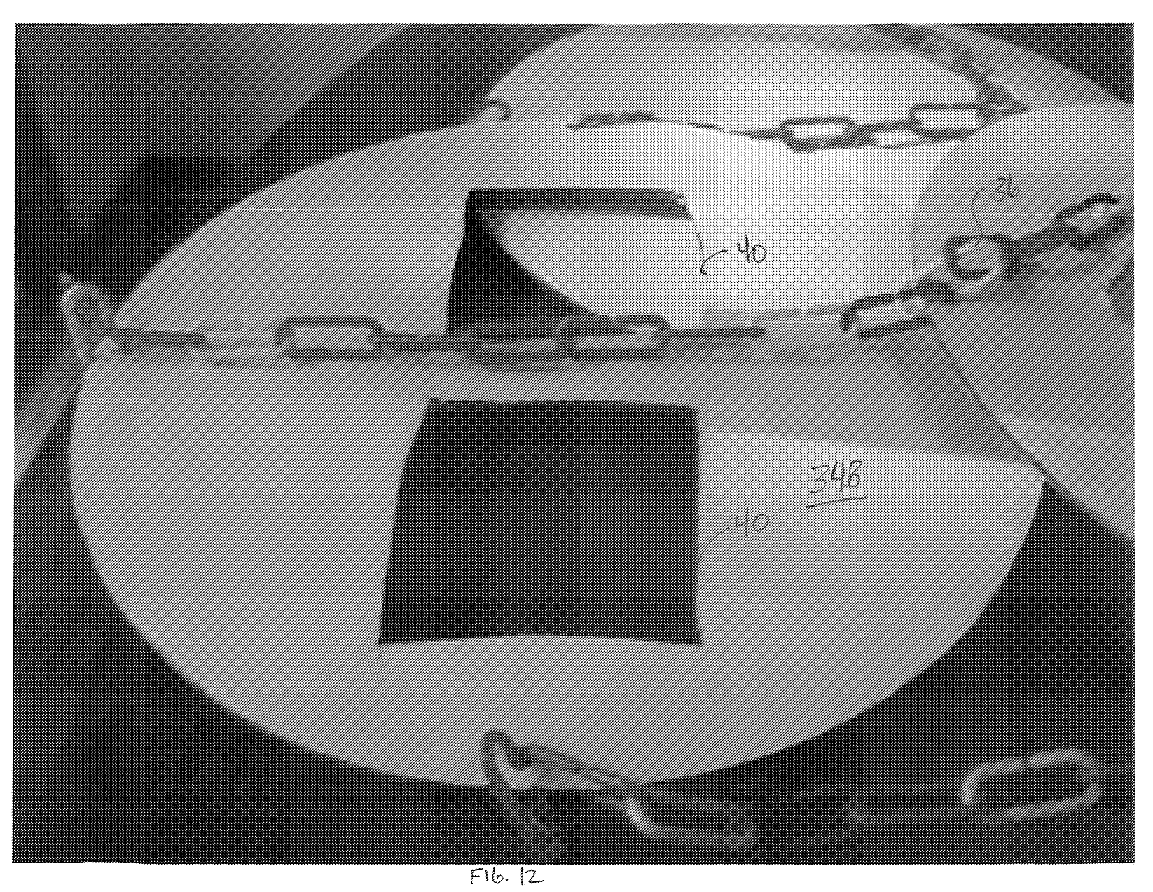

One preferred embodiment of the structure to hold the containers and provide the hanging function of the mobile is illustrated in FIGS. 9-12. Such a hanging structure includes a supporting structure comprising multiple tiered hanging platforms trays or the like which may include apertures at each measurement tier or level. Such a supporting structure which includes trays or platforms with apertures may form a harness for holding respective containers at each tier or level. In one preferred embodiment as illustrated, multiple trays are provided. A first tray includes one aperture 38 for gallon tier 34A, a second tray includes two apertures 40 for the half-gallon tier 34B, a third tray includes four apertures for the quart tier (not shown), a fourth tray includes eight apertures for the pint tier (not shown), and a fifth tray includes sixteen apertures for the half-pint tier (not shown). Each of the trays or platforms maybe circular, square, rectangle or formed in other shapes appropriate for the application. It is preferred that each platform be made of lightweight material with enough strength to hold the empty containers. Such lightweight material may include thermoset or thermosetting plastics including but not limited to polyurethanes, polyesters, epoxy resins and phenolic resins plastic, and the like. Other preferred light weight material may include thermoplastics such as polyethylene (PE), polypropylene (PP), polyvinyl chloride (PVC), polyethylene terephthalate (PET or PETE), Polystyrene, Styrofoam, Polyethylene, Low Density Polyethylene (LDPE) and High Density Polyethylene (HDPE) and the like.

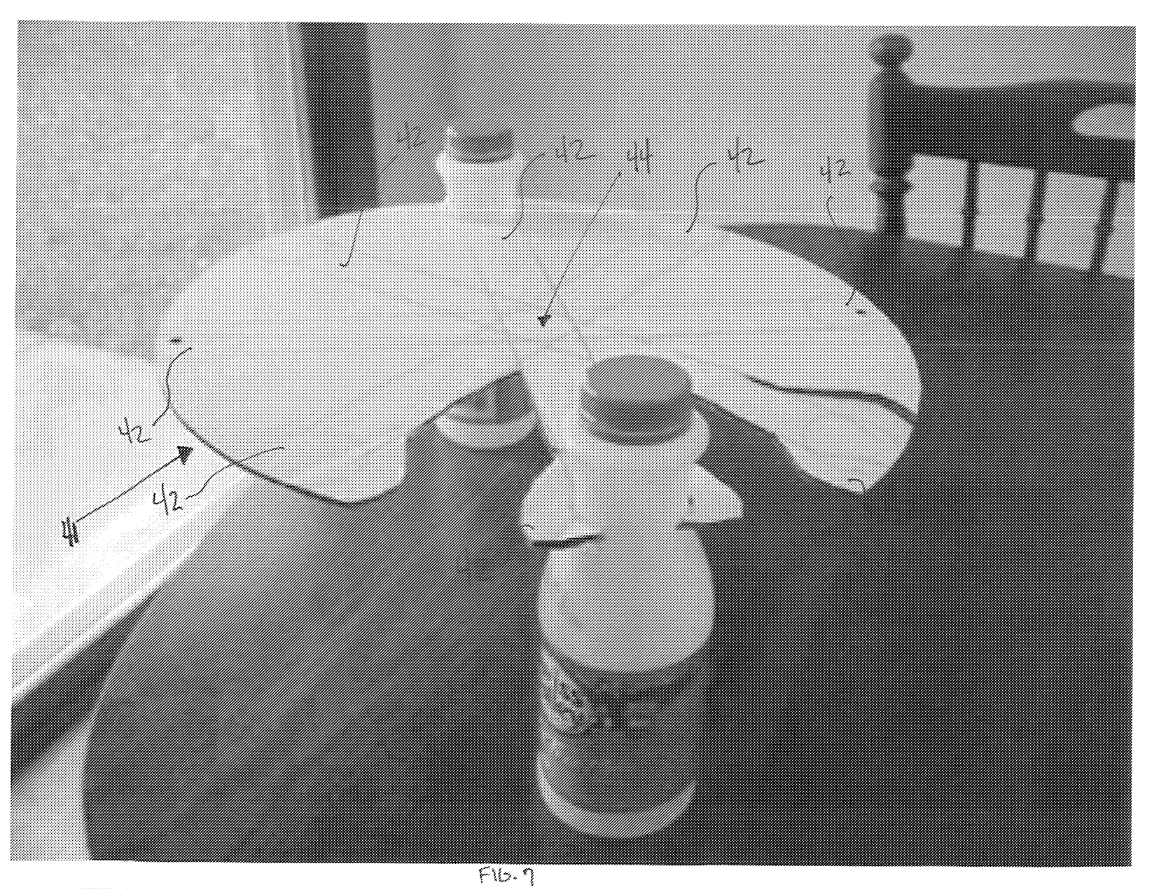

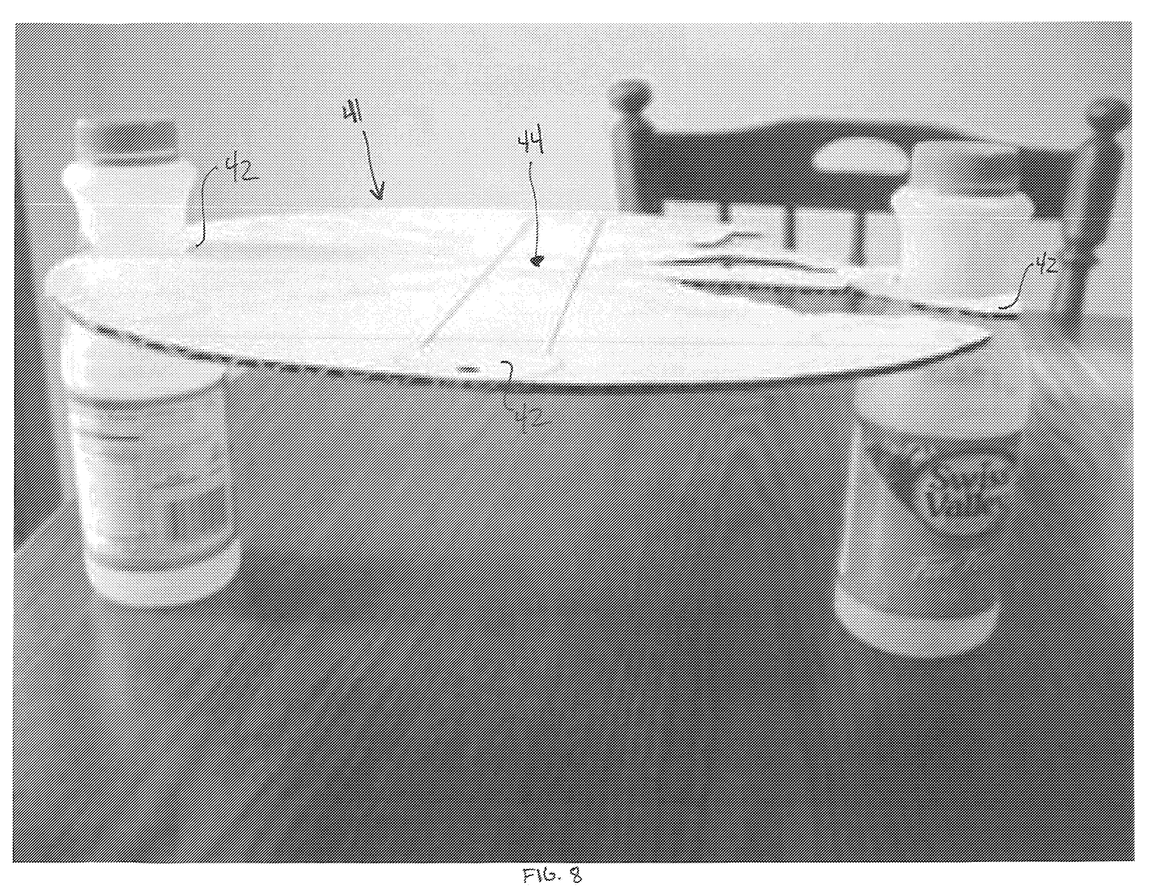

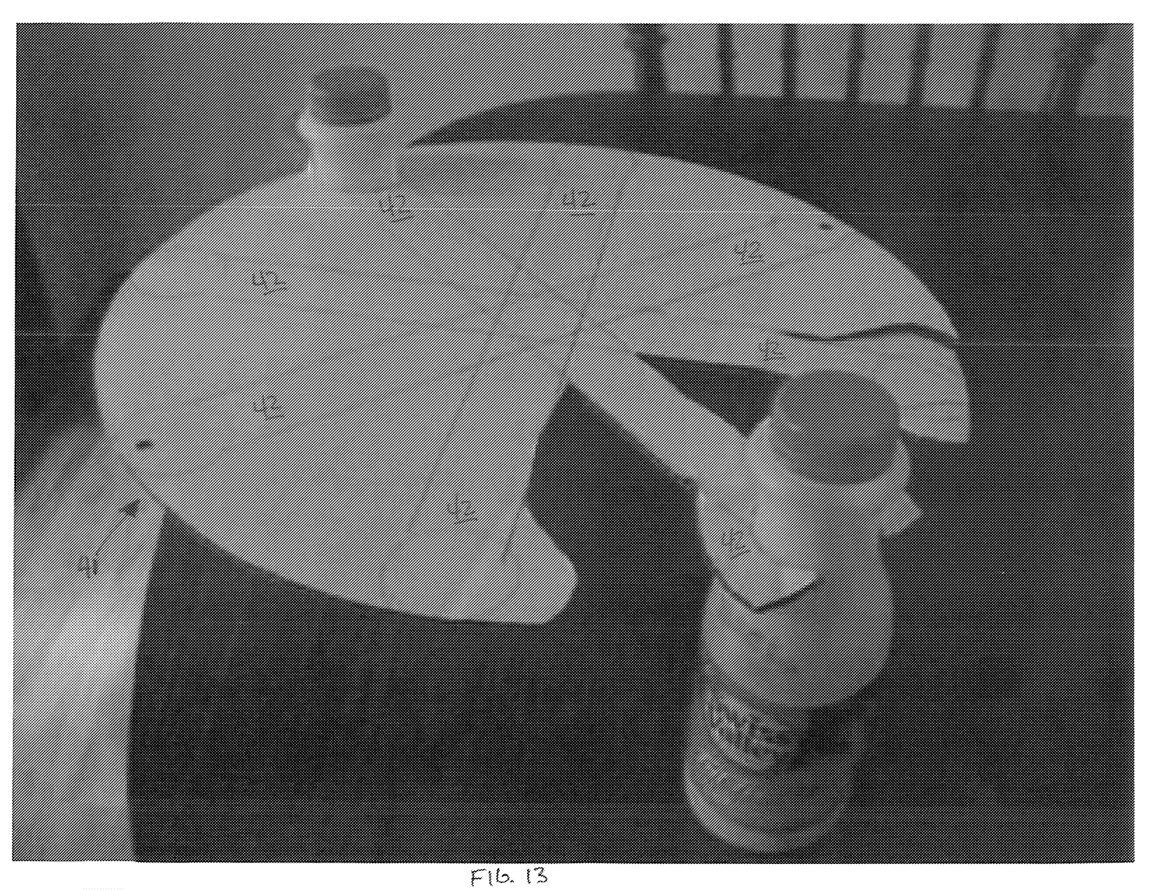

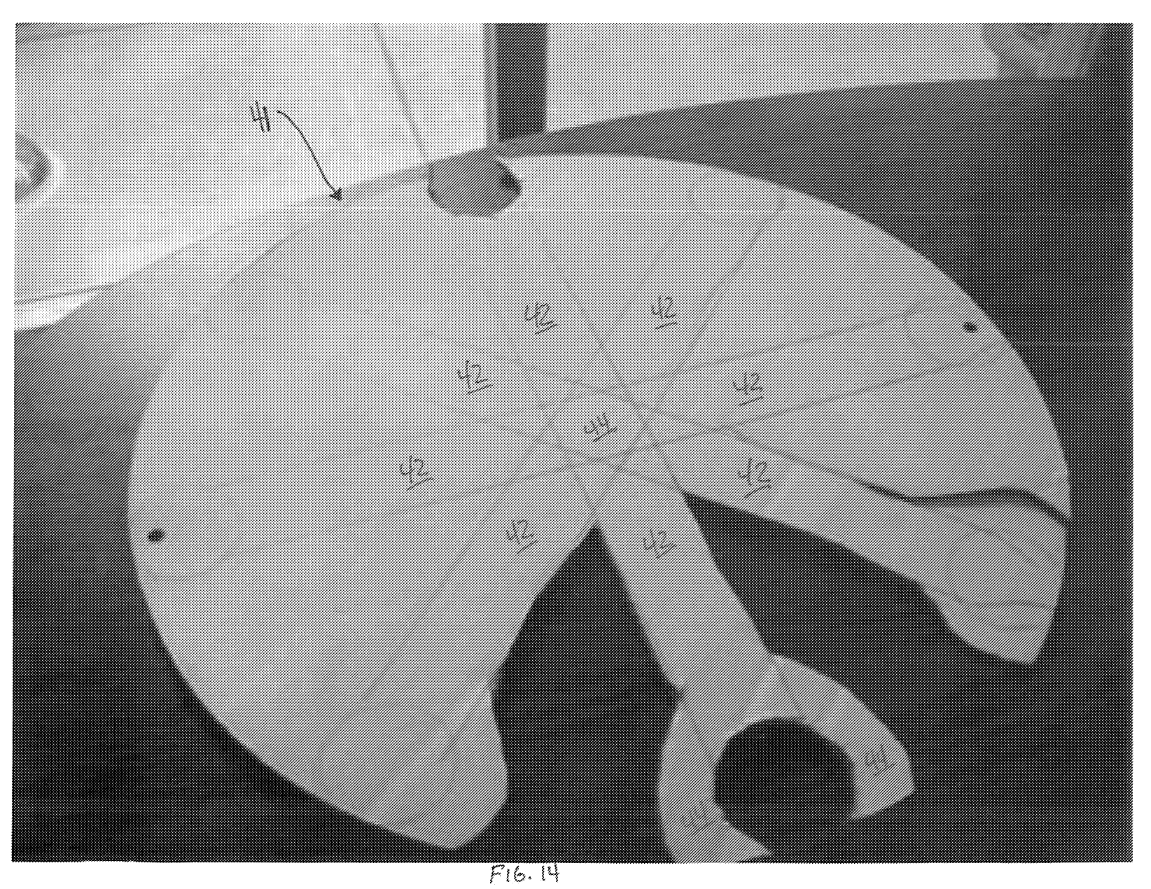

Yet another preferred embodiment, illustrated in FIGS. 7, 8, 13 and 14, includes a supporting structure which forms a platform with multiple arms each having a corresponding opening to insert, hang or otherwise affix one or more of the containers depending on the level or tier. Specifically, multiple arms 42 are formed in circular platform 41, centered around hub 44. Hub 44 provides the support with one or more dowel(s) (not shown) to connect each level or tier together. The top level preferably includes a dowel and an attaching structure (not shown) which provides a hanging connection of the complete mobile structure when assembled. Hub 44 may include one or more connection points. Such connection points may be one or more of a feed through attaching structure which provides one or more apertures to accept the connector such as the dowel, chain, rope or other fastener. It is also contemplated that the hub attaching structure or connection points include adjustability, such as with a set screw, pin, connector or other position enhancing structure, to allow the dowel or other connector to position or otherwise adjust each level or tier of the mobile. It is also contemplated that hub 44 may include a connection which provides an abutment or support for positively inserting, positioning and securing the dowel or other connector, which then positively secures each level or tier to one another.

While the platforms 41 are illustrated as circular in configuration, any shaped platform may be used depending on the desired environment and the method in which the mobile is hung or otherwise positioned. Each platform 41 is preferably made of lightweight but heavy duty plastic as described above, with an appropriately shaped opening or openings to accept and hold the respective containers on a given level. A preferred opening includes arms 44 at the outside end of arms 42 which provide the support to hang any one of the containers 5, 6, 7, 8 or 9 as illustrated in FIG. 1. Each level can be interchanged in assembly to illustrate and teach the equivalencies between each respective level. One gallon 5 is equivalent to two half-gallons 6 and four quarts 7 and eight pints 8 and sixteen half-pints 9. Accordingly, the level of the one gallon container 5 can be associated with any one of the lower levels individually or in combination. As will be understood, to achieve the hanging function, the gallon must be place at the top with any of the successive levels below, following in any order. It is contemplated that any such measurement system and corresponding equivalences may be shown and taught in this manner. Accordingly, such devices and methods are capable of teaching International System (SI) Metric System, Imperial units, British units, English units and any other such system of units.

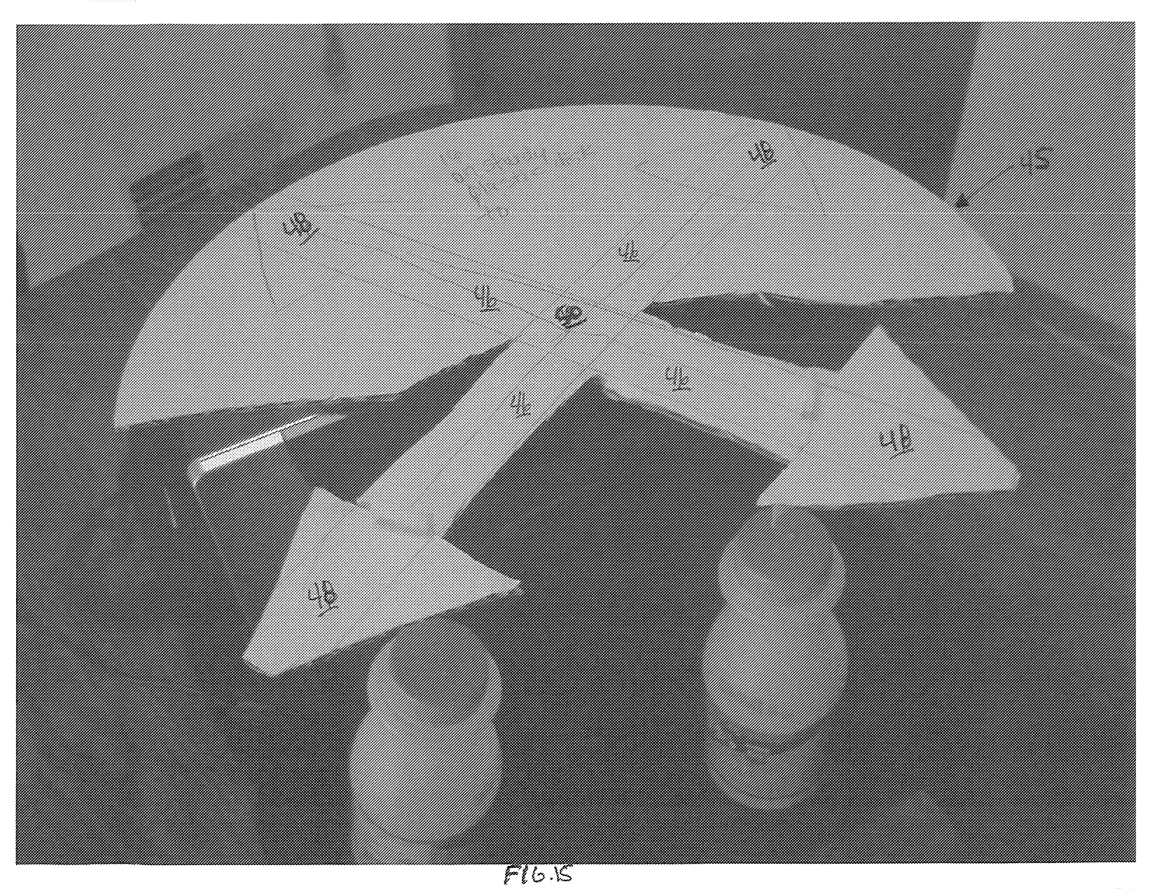

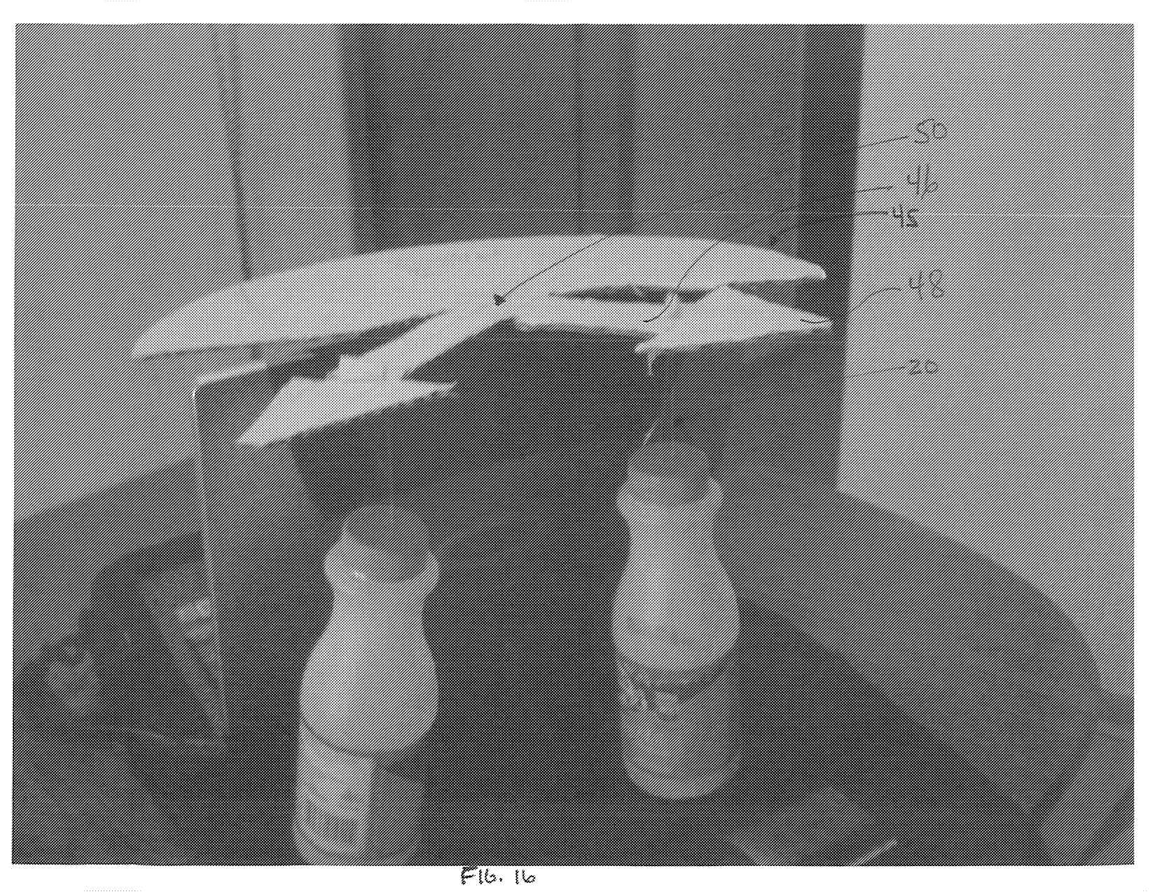

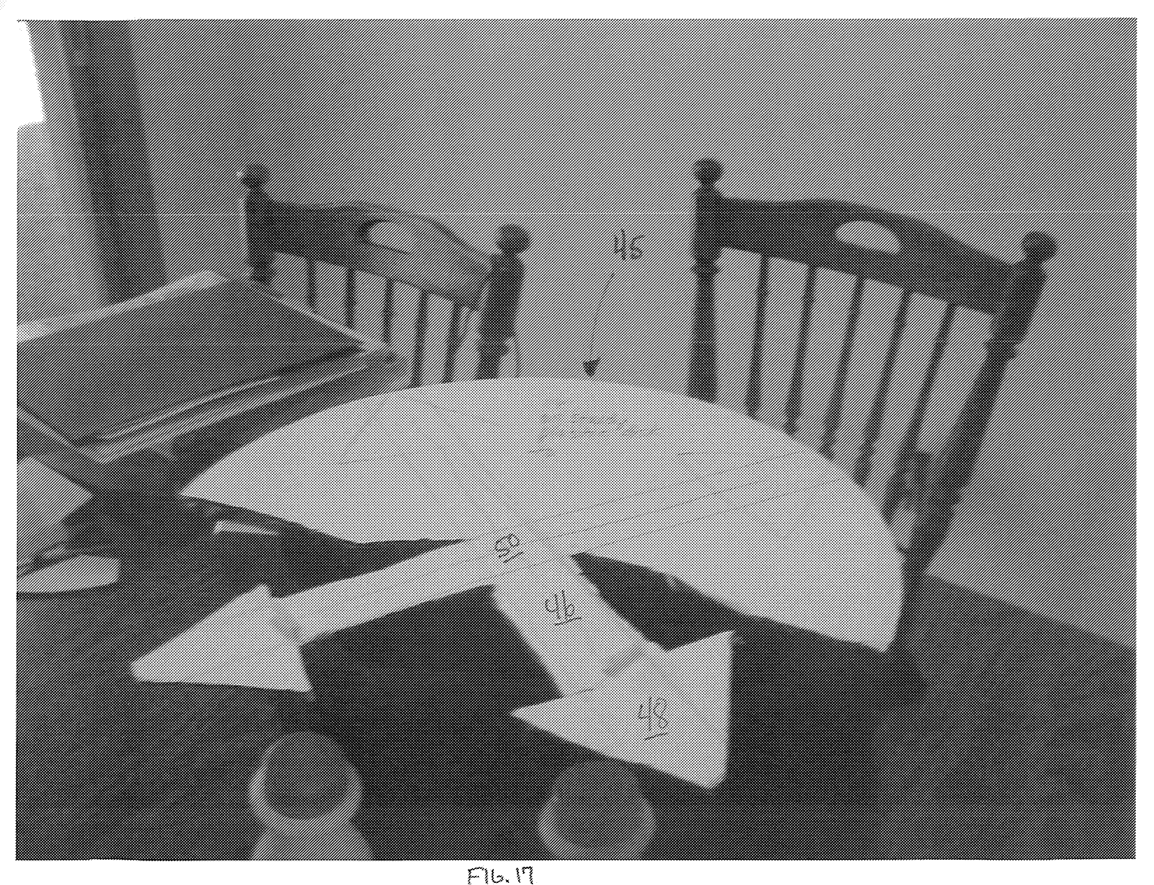

An additional preferred embodiment of the platform is illustrated in FIGS. 15-17 showing details of how the supporting structure or platform 45 may be constructed. The structure includes multiple arms 46 which include securing structure such as arrow heads 48. Arrow heads 48 each include areas, such as the indentations of the arrow heads 48, to grasp hanging elements such as string, wire or monofilament line 20. Platform 45 includes hub 50 which provides a preferred connection point for each tier or level as shown in FIGS. 1, 9 and 10. Hub 50 may be connected to the hub on another level in a variety of ways including but not limited to dowels, rods, chain, wire, rope, cord and like fastening or connecting elements. Containers 5, 6, 7, 8 and 9 are placed on one or more of arms 46 at or near arrow heads 48 by hanging string or monofilament line 20 over arrow heads 48. It will be appreciated that a variety of connectors including string, line, wire, dowels, rods, chain, wire, rope, cord or a variety of other fastening or connecting elements, all of which are contemplated for use in connecting the tiers or levels together as well as connecting containers 5, 6, 7, 8 and 9 to the platform or other attaching or holding structure as described herein.

Another preferred embodiment includes a thin but durable and unbreakable plate like member made from one or more of the lightweight plastic or other materials described above. The plate like member is sized to fit within the dimensions of the bottom of each container and adhered thereto. The plate like member includes appropriate apertures to provide attachment points for the containers on the level below. In a preferred embodiment, any of the containers may be disassembled such that each container may set flat and stable on a surface to allow the containers to be used as a manipulative. It is contemplated that each container may be filled with liquid such as water, colored water or similar liquid or substance to allow visual determination of the capacity of each container and each equivalent container or level of containers. It is also contemplated that each of the containers must be able to be assembled and disassembled. Construction in this manner allows the containers to be assembled to form a mobile to hang in a classroom or other learning environment as a visual learning aid until there is a need to disassemble the mobile structure so that the containers can be used as a manipulative. This allows each container to be used hands-on by each student or special needs individual and provides the opportunity to fill the containers to teach measurements, capacity, volume and corresponding equivalence.

Several preferred connectors to attach each level of the containers to one another may include, but are not limited to, string, line, wire, dowels, rods, chain, wire, rope, cord, snap connectors, hook and eye connectors, Velcro®, adhesive, putty, clips, latches and the like. It is desired that the structure that holds the containers is interchangeable for each tier or level to show equivalency between the respective tiers or levels. It may also be desirable and is contemplated herein that the connecting structures, platforms and other retaining members may be used interchangeably and multiple styles may be used in one teaching aid device. It is preferred that any such connection allow for use of each container as a manipulative so that liquid can be poured into each container. This provides the function of a teaching aid to show equivalency in measurement and capacity.

In construction, consideration must be given as the mobile is used as a teaching aid and will be handled by a variety of school aged and special needs individuals of all ages. As such the mobile may be taken apart and put back together repeatedly and must be durable to remain usable in such a demanding environment. Furthermore, the safety of students who will be using the teaching aid and manipulative must be considered in manufacture and use of the device.

While the illustrated preferred embodiment includes clear containers, it is contemplated that white, opaque or clear plastic may be utilized. In addition, it is also contemplated that the container may be provided is various different colors to help students visualize and immediately understand equivalencies through associating colors with specific measurements, volumes or the like. For example, the color blue may associate with the gallon container, the color red may associate with the half gallon containers and the like. This type of association may also play a part in a study guide or other lesson plan to standardize the teaching of measurements, capacities and the like.

It is also contemplated that the teaching aid and containers may be used as visual to show measurement for cooking and preparation of recipes. In addition, the containers may be used as measuring tools for a variety of uses. In addition, it is contemplated that educational integrated lesson plans for students may be prepared using commonly available containers including but not limited to projects such as constructing a mask from gallon container, various sized containers constructed into a water game, various sized terrariums, a picture mobile and the like. Various types and sizes of platforms can be constructed such that students may participate in recycling projects using various container sizes while learning measurements and other similar common or everyday activities.

Each of the containers may include indicia which may be written in ink, or removably positioned on each container with cut-outs of different types of materials or a different color from which the containers are made. Such indicia may be provided in the form of perforated cards, cut outs or the like for affixing to the containers to use in the teaching process and may be part of a lesson plan, study guide or other additional written teaching aid or guide.

The present invention is also directed to a method of teaching students. The method of teaching students includes using the teaching aid 10 described and shown herein. In a preferred embodiment, a teacher displays the teaching aid hung as a mobile to students and discusses the equivalencies on each level of the mobile. Then, the teacher allows the students to disassemble the mobile and remove the containers, asking the student to re-assemble the mobile into its original form. As alternatives, the teachers may disassemble only a portion of the mobile and ask the students to guide the teacher in re-assembling the mobile structure. Alternatively, the teacher disassembles the mobile structure, hangs the gallon to begin the mobile and institutes a game with two teams where the students begin to reassemble the mobile structure in various correct configurations obtaining points for correctly constructing various levels and equivalencies. The game may be timed and points awarded for each level, a winner being determined at the end of a given or predetermined time period.

Alternatively, the method of using the teaching aid may include a self-teaching method, where the student handles the teaching aid 10, and learns about the liquid measurements by himself or herself. The method may include a student re-assembling the mobile individually or in groups. If multiple mobiles are available, timing the re-assembly individually or by teams to provide a group learning experience would also be contemplated. By using liquid containers as described herein students and small children would be or become familiar with the standard container sizes and shapes, for example; a gallon milk container, a quart juice or milk container, or pint milk or juice container. Particularly, the students are able to relate measurements, which may have been previously esoteric, to something in their everyday lives. For students that learn better by visual methods, the teaching aid 10 creates an impression in a student's mind that he or she can later visualize, even when the model 10 is not available. Because the teaching aid 10, and all of the models associated therewith, may be made of materials that are sturdy, the teaching aid 10 may be passed around to the students so that they can see and handle the models themselves without the fear of harming themselves or the teaching aid, while also learning by tactile stimulation. Accordingly, the present invention includes both a unique teaching aid 10 and a unique method of teaching students about liquid measurements. Reference throughout this specification to “one embodiment,” “an embodiment, “a preferred embodiment” or similar language means that a particular feature, structure, or characteristic described in connection with the embodiment is included in at least one embodiment of the present invention. Thus, appearances of the phrases “in one embodiment,” “in an embodiment,” “in a preferred embodiment,” and similar language throughout this specification may, but do not necessarily, all refer to the same embodiment.

Furthermore, the described features, advantages, and characteristics of the invention may be combined in any suitable manner in one or more embodiments. One skilled in the relevant art will recognize that the invention may be practiced without one or more of the specific features or advantages of a particular embodiment. In other instances, additional features and advantages may be recognized in certain embodiments that may not be present in all embodiments of the invention.

While the present invention has been described in connection with certain exemplary or specific embodiments, it is to be understood that the invention is not limited to the disclosed embodiments, but, on the contrary, is intended to cover various modifications, alternatives, modifications and equivalent arrangements as will be apparent to those skilled in the art. Any such changes, modifications, alternatives, modifications, equivalents and the like may be made without departing from the spirit and scope of the invention.

It should be emphasized that the above-described embodiments of the present invention are merely preferred embodiments, and are merely set forth for a clear understanding of the principles of the invention. Many variations and modifications may be made to the above-described embodiments without departing from the spirit and principles of the invention. All such modifications and variations are intended to be included herein within the scope of this disclosure and the present invention.

What is claimed is:

1. A teaching aid for teaching measurement, comprising:
a gallon container, the gallon container having a top, a bottom, a side wall;
two half-gallon containers, each half-gallon container having a top, a bottom, a side wall;
the two half-gallon containers positioned with respect to the gallon container, at least two liquid quart containers, each quart container each having a top, a bottom, a side wall;
the at least two quart containers positioned with respect to at least one of the half-gallon containers, at least two pint containers, each pint container having a top, a bottom, a side wall;
the at least two pint containers positioned with respect to at least one of the quart containers, at least two half-pint containers, each half-pint container having a top, a bottom, a side wall; and
the at least two half-pint containers positioned with respect to at least one of the pint containers.

2. The teaching aid of claim 1 wherein the gallon container, half-gallon container, quart container, pint container, and half-pint container are affixed below one another.

3. The teaching aid of claim 1 wherein the gallon container, half-gallon container, quart container, pint container, and half-pint container are removably affixed below one another.

4. The teaching aid of claim 1 wherein the gallon container, half-gallon container, quart container, pint container, and half-pint container are removably affixed below and interchangeable with one another.

5. The teaching aid of claim 1 wherein the gallon container, half-gallon container, quart container, pint container, and half-pint container are affixed to one another with a connector.

6. The teaching aid of claim 5 wherein the connector comprises at least one of a hook and loop fastener, a magnet, a hook, and a latch.

7. The teaching aid of claim 1 wherein the containers are affixed to one another with a mounting agent.

8. The teaching aid of claim 7 wherein the mounting agent is at least one of an adhesive, a hook and loop fastener, a tray, a harness, a chain, a rope and a dowel.

9. The teaching aid of claim 1 wherein the gallon container, the half-gallon containers, quart containers, pint containers, and half-pint containers form a mobile.

10. The teaching aid of claim 1 wherein the gallon container, half-gallon containers, quart containers, pint containers, and half-pint containers are configured to hang.

11. The teaching aid of claim 1 wherein the gallon container, half-gallon containers, quart containers, pint containers, and half-pint containers are formed from resilient plastic.

12. The teaching aid of claim 1 wherein the gallon container, half-gallon containers, quart containers, pint containers, and half-pint containers are formed from clear plastic.

13. The teaching aid of claim 1 wherein the gallon container, half-gallon containers, quart containers, pint containers, and half-pint containers are formed from colored plastic.

14. The teaching aid of claim 1 wherein the gallon container, half-gallon containers, quart containers, pint containers, and half-pint containers are configured to hold liquid.

15. The teaching aid of claim 1 wherein the gallon container, half-gallon containers, quart containers, pint containers, and half-pint containers include indicia identifying each container.

16. The teaching aid of claim 13 wherein the indicia is removable from each container.

17. A teaching aid for teaching measurement comprising:
a liquid gallon container, the gallon container having a top, a bottom, a side wall;
two liquid half-gallon containers, each half-gallon container having a top, a bottom, a side wall;
the two half-gallon containers positioned on a mounting structure with respect to the gallon container, at least two liquid quart containers, each quart container each having a top, a bottom, a side wall;
the at least two quart containers positioned on a mounting structure with respect to at least one of the half-gallon containers, at least two liquid pint containers, each pint container having a top, a bottom, a side wall; and
the at least two pint containers positioned on a mounting structure with respect to at least one of the quart containers, at least two liquid half-pint containers, each half-pint container having a top, a bottom, a side wall; the at least two half-pint containers positioned on a mounting structure with respect to at least one of the pint containers whereby the containers are configured to form a mobile.

18. The teaching aid of claim 17 wherein the containers are configured to hang and are interchangeable.

19. A teaching aid for teaching measurement comprising:
a liquid gallon container, the gallon container having a top, a bottom, a side wall;
two liquid half-gallon containers, each half-gallon container having a top, a bottom, a side wall; the two half-gallon containers positioned below the gallon container, at least two liquid quart containers, each quart container each having a top, a bottom, a side wall;
the at least two quart containers positioned below at least one of the half-gallon containers, at least two liquid pint containers, each pint container having a top, a bottom, a side wall;
the at least two pint containers positioned below at least one of the quart containers, at least two liquid half-pint containers, each half-pint container having a top, a bottom, a side wall; and
the at least two half-pint containers positioned below at least one of the pint containers whereby the containers are configured to form a mobile.

20. The teaching aid of claim 19 wherein the gallon container, the half-gallon containers, the quart containers, the pint containers and the half-pint containers are configured to hang.

21. The teaching aid of claim 19 wherein the gallon container, the half-gallon containers, the quart containers, the pint containers and the half-pint containers are interchangeable.

22. The teaching aid of claim 19 wherein the gallon container, the half-gallon containers, the quart containers, the pint containers and the half-pint containers are attached to a supporting structure.

23. The teaching aid of claim 22 wherein the gallon container, the half-gallon containers, the quart containers, the pint containers and the half-pint containers are removably attached to the supporting structure.

24. The teaching aid of claim 22 wherein each of the gallon container, the half-gallon containers, the quart containers, the pint containers and the half-pint containers are attached to a supporting structure and each supporting structure is removably attached to another supporting structure.

25. The teaching aid of claim 24 wherein each supporting structure is connected to another supporting structure by at least one of a dowel, a chain, a rope, a wire and a rod.
